(19) United States
(12) Patent Application Publication
(10) Pub. No.: US 2026/0278410 A1
(43) Pub. Date: Sep. 17, 2026

(54) KNOWLEDGE MARKET SERVER AND OPERATING METHOD THEREOF

(71) Applicant: Jong Yoon CHUN, Yeoju-si (KR)

(72) Inventor: Jong Yoon CHUN, Yeoju-si (KR)

(21) Appl. No.: 19/667,467

(22) Filed: May 4, 2026

Related U.S. Application Data
(63) Continuation of application No. PCT/KR2024/017676, filed on Nov. 8, 2024.

(30) Foreign Application Priority Data
Nov. 9, 2023 (KR) 10-2023-0154585

(51) Int. Cl. G06N 5/022; G06N 20/00

(52) U.S. Cl. CPC G06N 5/022; G06N 20/00

(57) ABSTRACT

A method of operating a knowledge market performed by a knowledge market server may include acquiring knowledge information from knowledge suppliers, the knowledge information including details of knowledge that a knowledge supplier has, a personal profile of the knowledge supplier, and a cost associated with providing the knowledge information. The method may also include acquiring an initial query regarding knowledge demand from a knowledge demander; and recommending, to the knowledge demander, the knowledge suppliers using a well-defined query, the well-defined query clarifying the knowledge demand obtained from a response that is acquired by making a request for the acquired knowledge information from knowledge suppliers and initial query on the knowledge demander or a detailed request for the initial query, to the knowledge demander. Information usable for recognizing identification of the knowledge suppliers or the knowledge demander may be processed to be blinded to prevent exposure.

### CROSS REFERENCE TO RELATED APPLICATIONS

This is a continuation application of International Patent Application No. PCT/KR2024/017676 filed on Nov. 8, 2024, which claims priority to Korean patent application No. 10-2023-0154585 filed on Nov. 9, 2023, contents of each of which are incorporated herein by reference in their entireties.

### BACKGROUND

### Technical Field

The present disclosure relates to a knowledge market server and an operating method thereof.

### Description of Related Technology

Each individual has knowledge based on their own experience and the like. For example, a way to remove a stain from clothes, or a way to easily remove a lid from a sealed container with less effort, and the like fall into this category. Furthermore, university professors or corporate researchers possess advanced knowledge in their respective fields.

### SUMMARY

One aspect is a knowledge market that enables the transaction of knowledge between knowledge suppliers and knowledge demanders. In this process, accurately identifying and providing the knowledge needed by the knowledge demanders may be included in these objects.

In addition, enabling the knowledge supplier to earn income by providing knowledge and the knowledge demanders to smoothly obtain desired knowledge through the aforementioned knowledge market may also be included in the aforementioned objects.

However, the aspects are not limited those described herein.

Another aspect is a knowledge market server comprising: a memory storing at least one instruction; and a processor, wherein knowledge information from each of multiple knowledge suppliers is acquired through the at least one instruction being executed by the processor, wherein the knowledge information includes: (a) details of knowledge that a knowledge supplier has; (b) a personal profile of the knowledge supplier; and (c) a cost associated with providing the knowledge information, wherein an initial query regarding a knowledge demand is acquired from a knowledge demander, wherein at least one of the multiple knowledge suppliers is recommended to the knowledge demander using a well-defined query, the well-defined query clarifying the knowledge demand obtained from a response that is acquired by making a request for the acquired (i) knowledge information from multiple knowledge suppliers and (ii) initial query on the knowledge demander or a detailed request for the initial query, to the knowledge demander, and wherein at least some of information usable for recognizing identification of the multiple knowledge suppliers or the knowledge demander is processed to be blinded to prevent exposure.

In some embodiments, the knowledge information is acquired by web crawling or by being provided by each of the multiple knowledge suppliers.

In some embodiments, information on at least one of a major, a specialty, an educational background, patent literature, articles, posts, and seminar performance history of each knowledge supplier is acquired through web crawling.

In some embodiments, from at least one of the multiple knowledge suppliers, the server receives a selection of predetermined knowledge information among knowledge information from the corresponding knowledge supplier, and wherein knowledge information used in the recommendation is the predetermined knowledge information.

In some embodiments, each of the multiple knowledge suppliers is provided with quantity information on knowledge demand recommended to a corresponding knowledge supplier.

In some embodiments, the detailed request includes at least one of a range of required costs, a range of required time periods, a level of competence, a major, experience, gender, age, nationality, residence, and the number of patents or papers listed in which the name is listed in relation to the initial query, in order to solve the initial query.

In some embodiments, the knowledge demander's response to the detailed request includes a thing to be solved or achieved as the knowledge demand, wherein the thing to be solved or achieved includes: (a) a time of the thing to be solved and issue occurrence, a cause of the issue occurrence, a type and characteristics of an object related to the issue, a period for solving the issue, and costs for solving the issue; and (b) a specific specification of the thing or target to be achieved, a period for achieving the thing or target, costs for achieving the thing or target, a current status of the knowledge demander related to the thing or target, and wherein the specific specification includes at least one of a specification in terms of structure, composition, construction, or design or a specification in terms of performance, efficacy, or effect.

In some embodiments, a personal profile of the knowledge supplier includes at least one of a name, age, gender, nationality, available languages, address, educational background, major, field of expertise, awards, or years of experience in the field of expertise.

In some embodiments, the details of the knowledge that the knowledge supplier has includes at least one of a patent listing the knowledge supplier as an inventor, an academic paper, post, or seminar listing the knowledge supplier as an author or presenter, or a description of the knowledge to be provided

In some embodiments, the description of the knowledge to be provided includes a description of solvable issues and/or a description of achievable targets, wherein the description of solvable issues includes at least one of a cause of the issue, a type and characteristics of objects related to the issue, a time required for issue resolution, and a cost of issue resolution, wherein the description of achievable targets includes at least one of specific specifications of the target, a time required to achieve the target, and a cost to achieve the target, and wherein the specific specifications have at least one of specifications in terms of structure, composition, construction, or design, and specifications in terms of performance, efficacy, or effect.

In some embodiments, the description of the knowledge to be provided is derived from actual case experiences of the knowledge supplier.

In some embodiments, the detailed request includes at least one of the predefined characteristics regarding the initial query and contrasting characteristics among the knowledge suppliers sorted from multiple knowledge suppliers in relation to the initial query.

In some embodiments, two or more knowledge suppliers from multiple knowledge suppliers are sorted using the acquired initial query, extracting the detailed request is extracted from contrasting characteristics among the sorted two or more knowledge suppliers, and wherein the detailed request requested to the knowledge demander includes the extracted detailed request.

In some embodiments, a first step is performed of sorting a part from the sorted two or more knowledge suppliers using the extracted detailed request, and a second step is performed of additionally extracting the detailed request from contrasting characteristics among the sorted part of knowledge suppliers, wherein the first and second steps are repeatedly performed until the number of individuals of the part sorted in the first step is equal to or less than a preset number.

In some embodiments, the contrasting characteristics are defined by information belonging to the same type but differing in content or by information with different affiliation ranges of values when the information on the knowledge suppliers related to the initial query is classified according to type.

In some embodiments, types of contrasting characteristics are determined depending on the sorting results for the knowledge suppliers related to the initial query.

In some embodiments, the contrasting characteristics are multiple and have different priorities, the priorities being assigned according to least numerical deviation of the knowledge suppliers belonging to each group when the sorted knowledge suppliers are classified into multiple groups using each characteristic.

In some embodiments, the detailed request includes the contrasting characteristics corresponding to a highest priority up to an nth priority among the multiple contrasting characteristics.

In some embodiments, the recommendation is performed by a recommendation language model trained by fine-tuning a pre-trained model based on at least one of papers, patent publications, and utility model publications.

In some embodiments, reinforcement learning by human feedback is performed in the fine-tuning (RLHF).

In some embodiments, in the reinforcement learning by human feedback, a training process using a dialogue set generated by humans and a training process using rankings selected by humans to multiple outputs generated by the language model are performed.

In some embodiments, multiple items are further used in the recommendation, and wherein the multiple items include at least one of a recommendation history in a predetermined period for each knowledge supplier, a history of matching successes after the recommendation, a degree to which the knowledge demand is satisfied in the matching, the number of patents and/or papers related to the knowledge demand, and the years of experience of the knowledge supplier related to the knowledge demand, a existence of a legal risk.

In some embodiments, the legal risk is determined according to whether knowledge information from each knowledge supplier corresponds to an employee invention of a current or former affiliated organization of the corresponding knowledge supplier.

In some embodiments, when the knowledge information from the knowledge supplier recommended to the knowledge demander is determined to correspond to an employee invention, a warning message indicating the possibility that the knowledge information from the recommended knowledge supplier corresponds to an employee invention is controlled to be displayed to at least one of the knowledge demander or the recommended knowledge supplier.

In some embodiments, information that the warning message has been displayed to at least one of the knowledge demander and the recommended knowledge supplier is recorded in a predetermined blockchain.

In some embodiments, inclusion criteria or exclusion criteria to be considered in the recommendation are input from the knowledge demander, and the recommended knowledge supplier is an individual sorted by the inclusion criteria and the exclusion criteria among the multiple knowledge suppliers.

In some embodiments, a basis of the recommendation is provided as a reference material in the recommendation.

In some embodiments, the basis of the recommendation includes at least one of a history of the recommended individual handling initial queries of the same type in the past, a paper or patent of which the recommended individual is an author, or a video in which the recommended individual appears or is mentioned.

In some embodiments, two or more knowledge suppliers who form a team are recommended in the recommendation.

In some embodiments, the team is either designated by at least one of the two or more knowledge suppliers or recommended by a pre-trained language model for team recommendation using the knowledge information from each knowledge supplier.

In some embodiments, a contract to fulfill the knowledge demand is concluded between the knowledge supplier and the knowledge demander by the recommendation.

In some embodiments, the contract includes at least one of a period, consideration, an agreed scope between the contracting parties for the knowledge information from the knowledge supplier to be utilized, ownership of inventions that may be derived in the process of fulfilling the knowledge demand, or workability of a technology proposed for the knowledge demand.

In some embodiments, the consideration is determined to be different in a case where the agreed scope between the contracting parties for the knowledge information from the knowledge supplier to be utilized is limited to the knowledge demand and in a case where the agreed scope is specified to be expandable with the knowledge demand included.

In some embodiments, requests for the contract is acquired from each of the knowledge supplier and the knowledge demander by the recommendation, and a term sheet on which the acquired request is collected and described is generated and provided to each of the knowledge supplier and the knowledge demander by the recommendation.

In some embodiments, in the term sheet, requests on which mutual opinions have been agreed upon and requests on which mutual opinions have not been agreed upon are separately marked, among the acquired requests.

In some embodiments, when two or more knowledge suppliers are recommended to a knowledge demander, the knowledge supplier as a party to the contract is determined by a bidding among the two or more knowledge suppliers.

In some embodiments, prior to the conclusion of the contract, no knowledge information is controlled so as not to be provided from the knowledge supplier to the knowledge demander.

In some embodiments, at least one of the acquired knowledge information or the acquired knowledge demand is recorded on a blockchain.

In some embodiments, the blockchain is a private blockchain accessible and viewable only by authorized members.

In some embodiments, an interface for specifying ownership of the knowledge information delivered from the knowledge supplier to the knowledge demander is provided to the knowledge supplier and the knowledge demander.

In some embodiments, an interface for specifying a scope of rights and/or obligations of each of the knowledge supplier and the knowledge demander with respect to the outcome to which the knowledge information has been applied is provided to the knowledge supplier and the knowledge demander.

In some embodiments, an ease with which a third party acquires, from an outcome to which the knowledge information is applied, the applied knowledge information is inferred, and a consideration for providing the knowledge information, determined dependent on the inferred ease, is presented to at least one of the knowledge supplier or the knowledge demander.

In some embodiments, the consideration for providing the knowledge information is inversely proportional to the ease of acquisition of the applied knowledge information.

In some embodiments, at least one of the number of contracts that have been concluded through the knowledge market server or the number of contracts that are under negotiation is provided by technical field.

In some embodiments, it is verified whether an individual who is providing, has provided, or will provide knowledge information to the knowledge demander is the same individual as the knowledge supplier matched to the knowledge demander by the recommendation.

In some embodiments, the verification uses at least one of biometric information or identity card information on the individual.

In some embodiments, a time of payment for the consideration is controlled dependent on a process of providing the knowledge information.

In some embodiments, ownership of the knowledge information acquired from each of the multiple knowledge suppliers is exclusively vested in a corresponding knowledge supplier.

In some embodiments, the recommendation is performed after confirmation of the well-defined query from the knowledge demander.

Another aspect is a method of operating a knowledge market performed by a knowledge market server, the method comprising: acquiring knowledge information from each of multiple knowledge suppliers, the knowledge information including (a) details of knowledge that a knowledge supplier has, (b) a personal profile of the knowledge supplier, and (c) a cost associated with providing the knowledge information; acquiring an initial query regarding a knowledge demand from a knowledge demander; and recommending, to the knowledge demander, at least one of the multiple knowledge suppliers using a well-defined query, the well-defined query clarifying the knowledge demand obtained from a response that is acquired by making a request for the acquired (i) knowledge information from multiple knowledge suppliers and (ii) initial query on the knowledge demander or a detailed request for the initial query, to the knowledge demander, and wherein at least some of information usable for recognizing identification of the multiple knowledge suppliers or the knowledge demander is processed to be blinded to prevent exposure.

Another aspect is a non-transitory computer-readable recording medium storing a computer program programmed to perform each step included in the method, the method comprising: acquiring knowledge information from each of multiple knowledge suppliers, the knowledge information including (a) details of knowledge that a knowledge supplier has, (b) a personal profile of the knowledge supplier, and (c) a cost associated with providing the knowledge information; acquiring an initial query regarding a knowledge demand from a knowledge demander; and recommending, to the knowledge demander, at least one of the multiple knowledge suppliers using a well-defined query, the well-defined query clarifying the knowledge demand obtained from a response that is acquired by making a request for the acquired (i) knowledge information from multiple knowledge suppliers and (ii) initial query on the knowledge demander or a detailed request for the initial query, to the knowledge demander, and wherein at least some of information usable for recognizing identification of the multiple knowledge suppliers or the knowledge demander is processed to be blinded to prevent exposure.

In an embodiment, from the perspective of a knowledge demander, not only can the knowledge demander find a knowledge supplier to provide knowledge to him or her, but the knowledge supplier can also find a knowledge demander to whom they wish to provide his or her knowledge. Therefore, active transactions or exchanges of knowledge can be made.

### BRIEF DESCRIPTION OF THE DRAWINGS

FIG. 1 exemplarily illustrates a form in which a knowledge market server is connected over a network, according to an embodiment.

FIG. 2 conceptually illustrates a block diagram of a knowledge market server, according to an embodiment.

FIG. 3 conceptually illustrates an architecture for deep learning.

FIGS. 4 and 5 exemplarily illustrate a process performed in pre-training during transfer learning.

FIG. 6 exemplarily illustrates a flowchart representing a procedure for training a language model, according to an embodiment.

FIG. 7 exemplarily illustrates a concept that a different number of knowledge information may be recommended for each combination of knowledge information from a knowledge supplier.

FIG. 8 conceptually illustrates a process by which a well-defined query is generated from an initial query, according to an embodiment.

FIG. 9 exemplarily illustrates a concept in which a targeted knowledge supplier is selected from multiple knowledge suppliers by contrasting characteristics or detailed requests, according to an embodiment.

FIG. 10 exemplarily illustrates a concept of generating a term sheet, in accordance with an embodiment.

FIG. 11 exemplarily illustrates a flowchart for an operating method of a knowledge market server according to an embodiment.

### DETAILED DESCRIPTION

When it comes to knowledge that is necessary for daily life or knowledge in a specific technical field, sometimes the individual who has the knowledge will need to share or provide it to others, but there are instances where this is not possible. For example, when university professors or corporate researchers described above retire or leave their institutions, there are many cases where their knowledge is no longer being used and goes unexploited. Of course, such knowledge is sometimes passed down to successors, but it is difficult to fully transfer the know-how that the corresponding professor or researcher has acquired directly through experience.

Meanwhile, knowledge is needed not only by individuals but also by companies. For example, the aforementioned knowledge may be required not only for small things that occur in everyday life, such as how to educate a child or how to clean the house, but also for designing a product or a component of the product to be developed by an enterprise, resolving a trouble in the product or the component, and implementing a given function in the product or the component, and the like.

The advantages and features of embodiments and methods of accomplishing these will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present disclosure, if it is determined that detailed description of related known components or functions unnecessarily obscures the gist of the present disclosure, the detailed description thereof will be omitted. Further, the terminologies to be described below are defined in consideration of functions of the embodiments of the present disclosure and may vary depending on a user's or an operator's intention or practice. Accordingly, the definition thereof may be made on a basis of the content throughout the specification.

Hereinafter, before describing the technical ideas according to an embodiment, the terminology will be reviewed.

First, knowledge refers to the perception or understanding acquired through learning or practice regarding a certain object or principle, but it is not limited thereto. Such knowledge may include not only types acquired through experience in everyday life, but may also knowledge acquired by experts in their field of expertise, such as research and development know-how for products. However, it is not limited thereto.

Such knowledge may be manifested in various forms. For example, knowledge may be manifested through oral communication, websites such as social networking services, or in the form of patents or papers, as well as seminars in which the knowledge provider participates. In addition, knowledge may also be manifested in the form of know-how.

Such knowledge may be used across a variety of fields.

For example, there is something applicable in daily life, such as how to remove a stain from clothes or how to easily remove a lid from a sealed container with less effort.

Alternatively, some knowledge may be applicable for developing or designing products or components of these products. In such development or design, specifications of the product (design specification or performance specification, etc.) may be developed or designed. The outcome may be, but is not limited to, blueprints, etc.

Alternatively, some knowledge may be used to resolve a trouble in products or components. Alternatively, some knowledge may be used to implement a given function in products or components. Of course, the categories of knowledge are not limited thereto.

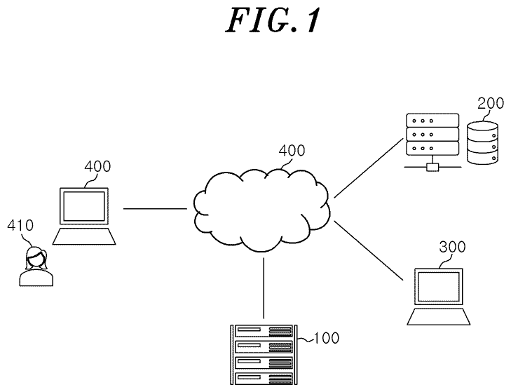

FIG. 1 exemplarily illustrates a form in which a knowledge market server is connected over a network, according to an embodiment.

With reference to FIG. 1, a knowledge market server 100 according to an embodiment may be connected via a network 500 to a terminal 400 of a knowledge demander 410, a terminal 300 of a knowledge supplier, or an external server 200, etc. Here, FIG. 1 is merely illustrative, and the spirit of the present disclosure should not be interpreted as being limited to what is illustrated in FIG. 1.

Here, the network 500 refers to a wireless or wired network. Among these, in case of a wireless network, at least one may be included, such as long-term evolution (LTE), LTE Advanced (LTE-A), code division multiple access (CDMA), wideband CDMA (WCDMA), universal mobile telecommunications system (UMTS), Wireless Broadband (WiBro), wireless fidelity (WiFi), Bluetooth, near field communication (NFC), and global navigation satellite system (GNSS), etc. In addition, in case of a wired network, at least one may be included, such as universal serial bus (USB), high definition multimedia interface (HDMI), recommended standard 232 (RS-232), local area network (LAN), wide area network (WAN), internet, and telephone network, etc.

Next, the terminal 400 is a terminal of the knowledge demander 410. Such a terminal 400 is not limited to what is illustrated in FIG. 1. For example, the terminal 400 may include a smartphone, a tablet PC, a desktop PC, or a server, etc.

The knowledge demander 410 may be a corporation, research institute, or university itself, or an employee of staff member affiliated with these entities. Alternatively, the knowledge demander 410 may include individuals who wish to solve problems they encounter in their daily lives, who may not require specialized knowledge, but need know-how for daily life.

Such a knowledge demander 410 requires the knowledge described above. Hereinafter, the need for knowledge by knowledge demander 410 will be referred to as a “demand. Such knowledge demand may include a variety of things. For example, as described above, the knowledge demand may include, but is not limited to, at least one of solving a problem encountered in daily life, designing a product or a component of the product to be developed, resolving a trouble in the product or the component, or implementing a given function in the product or the component.

The terminal 300 is a terminal of a knowledge supplier. Such a terminal 300 is not limited to what is illustrated in FIG. 1. For example, the terminal 300 may include a smartphone, a tablet PC, a desktop PC, or a server, etc.

A knowledge supplier refers to an individual who has knowledge in one or more fields. Such a knowledge supplier may be a natural person. More specifically, a knowledge supplier may be an individual who is free from the constraints of employee inventions. An individual free from the constraints of employee inventions refers to, for example, in case of an employee of staff member, an individual who possesses knowledge unrelated to the duties of the institution to which the individual currently belongs or has belonged in the past and is able to provide such knowledge. Alternatively, it may refer to an individual who, after leaving the institution to which the individual was affiliated, has acquired knowledge solely through personal effort and is able to provide such knowledge. Alternatively, it may refer to, among the professors, an individual who, without the facilities or support of a university, has acquired and possesses knowledge through independent research and development and is able to provide such knowledge. In some cases, although the knowledge may technically be an employee invention, if the institution has previously recognized that the knowledge is the exclusive property of the individual, then the individual possessing the knowledge may also be free from the constraints of employee invention, as described above. Of course, if an individual who is not affiliated with any institution or organization is acquiring the knowledge, that individual who is able to provide the knowledge may also be considered to be free from the constraints of the employee invention described above.

The external server 200 is configured to provide various information. Specifically, the server 200 may have a knowledge database established. Such a knowledge database may store, for example, patent documents or papers, etc. To this end, the knowledge database may access public sites for papers or patent documents and crawl the publicly available literature.

Alternatively, the knowledge database may store information acquired from knowledge supplier's or knowledge demander 410's major, field of expertise, and educational background, seminars held or scheduled to be held, homepages of organizations or institutions to which each knowledge demander 410 or knowledge supplier belongs or has belonged in the past, homepages of organizations similar to the organization or institution, or information acquired from video streaming sites where videos created and shared by each knowledge supplier are posted, etc. Additionally, content posted on these seminars, homepages, or video streaming sites, for example, information on seminar speakers and technologies or topics covered on homepages, may also be stored in the knowledge database. To this end, the aforementioned crawling, etc. may, of course, be performed.

The knowledge market server 100, according to an embodiment, is configured to enable the delivery or transaction of knowledge between the knowledge demander 410 and the knowledge supplier. The knowledge market server 100 may be implemented by a PC, server, or smart device, etc.

Specifically, in the knowledge market server 100, knowledge information from the knowledge supplier is acquired. Such knowledge information may be acquired from what the knowledge supplier has provided using his or her terminal 300, or may be acquired from the knowledge database provided on the external server 200, but is not limited thereto.

In this case, the acquired knowledge information may be acquired from each of multiple knowledge suppliers. That is, knowledge information may be acquired not only from multiple knowledge suppliers belonging to a single field, but also from multiple knowledge suppliers belonging to various fields. Therefore, the knowledge market server 100 may have a wide variety of knowledge information of numerous types.

Further, each piece of knowledge information may be acquired along with a detailed specification or details describing the corresponding knowledge information. For example, detailed things on who, what, when, why, and how may be acquired along with this knowledge information. That is, the detailed specification or details may refer to a detailed thing or exact fact regarding the knowledge information. This detailed specification or details may include, for example, at least one of a patent listing the knowledge supplier as an inventor, an academic paper, post, or seminar listing the knowledge supplier as an author or presenter, or a description of the knowledge to be provided

Here, the description of the knowledge to be provided may include a description of solvable issues and/or a description of achievable targets. Here, “solvable issues” refers to a problem, i.e., a situation that is abnormal or below standard. In contrast, “achievable targets” refer to a situation or future that is not a problem but is better than the present.

In this case, each of these solvable issues or achievable targets may include specific items as described below. For example, the aforementioned description of solvable issues may include at least one of a cause of the issue, type and characteristics of objects related to the issue, a time period required for issue resolution, or a cost of issue resolution.

In contrast, the aforementioned description of achievable targets may include at least one of specific specifications of the target, a time period required to achieve the target, and a cost to achieve the target. Here, the specific specifications may include at least one of specifications in terms of structure, composition, construction, or design, or specifications in terms of performance, efficacy, or effect.

Alternatively, according to an embodiment, each piece of knowledge information may further include cost information, which is an amount of money that the knowledge supplier wishes to receive as consideration for providing the corresponding knowledge information.

Alternatively, according to an embodiment, each piece of knowledge information may include a personal profile of the corresponding knowledge supplier. Here, the personal profile may include at least one of a name, age, gender, nationality, languages, address, educational background, major, field of expertise, awards, or years of experience in the field of expertise.

Meanwhile, according to an embodiment, the aforementioned details or detailed specification may be requested from the corresponding knowledge supplier to be provided by the knowledge supplier.

The acquired knowledge information in this manner may be updated. For example, information on newly published patent documents or papers, newly held seminars, newly established institutions or organizations, etc. may be acquired by web crawling or input from the owner of the corresponding information. The knowledge information on the knowledge market server 100 may be updated by the knowledge information acquired in this manner.

Meanwhile, an initial query representing a knowledge demand of the knowledge demander 410 is input to or acquired by the knowledge market server 100. Such an initial query may be acquired by the knowledge demander 410 inputting the initial query using his or her terminal 400. Alternatively, the initial query may be acquired by web crawling, etc. of technical requests uploaded by a specific organization or individuals on publicly accessible webpages, etc. Here, the acquirable knowledge demand is as described above. Therefore, further description will be omitted.

Here, the term “initial query” refers to a type of requirement that contains the matters requested by the knowledge demander. The term ““indicates that it is in the exact form as input by the demander, but is not limited thereto.

The initial query may be one or more sentences, and in some cases, may be in the form of a word, phrase, or clause. For example, “resolution of defects discovered in the process of using a PCR plate sealer” or “solutions for leakage occurring in water pipes” may be examples of such an initial query.

In the knowledge market server 100, a recommendation for matching between the knowledge supplier and the knowledge demander 410 is performed using the aforementioned knowledge information and the knowledge demand represented by the initial query.

Specifically, among the multiple knowledge information stored in the knowledge market server 100, one or more knowledge suppliers that possess the knowledge information required by the knowledge demander 410 may be recommended to the knowledge demander 410. Then, the knowledge demander 410 may select one or more of these knowledge suppliers that are most suitable for the knowledge demander. Then, a matching is made between the knowledge supplier and the knowledge demander 410, a contract is concluded accordingly, and subsequently, the knowledge may be substantially transferred or delivered.

In contrast, among the multiple knowledge demands stored in the knowledge market server 100, one or more knowledge demanders 410 with knowledge demands that the knowledge supplier wishes to provide may be recommended to the knowledge supplier. For example, a knowledge supplier seeking employment or wishing to create a source of income using his or her knowledge may want to find a knowledge demand where his or her knowledge can be utilized. In this case, a suitable knowledge demand may be recommended to the corresponding knowledge supplier. In this case as well, the knowledge provider may select one or more of the knowledge demanders 410 who are most suitable for himself or herself, resulting in a matching and contract, after which the knowledge may be substantially transferred or delivered.

That is, in an embodiment, from the perspective of a knowledge demander, not only may the knowledge demander find a knowledge supplier to provide knowledge to him or her, but the knowledge supplier may also find a knowledge demander to whom they wish to provide his or her knowledge. Therefore, active transactions or exchanges of knowledge may be made.

Here, the recommended or matched knowledge suppliers may be an expert, but are not necessarily limited thereto. For example, when a knowledge demander has a knowledge demand related to “accounting” it is not only “accountants” who are recommended or matched as knowledge suppliers, but also non-accountants who have experienced the accounting issues or accounting challenges faced by the knowledge demander may be recommended or matched as knowledge suppliers. To this end, in an embodiment, when recommending or matching a knowledge supplier, the knowledge supplier is not necessarily limited to having a professional license. In some cases, to ensure a non-expert with experience or knowledge that precisely aligns with or matches the needs of the knowledge demanders are recommended or matched, a weight may be higher on the degree of experience in the same situation as the knowledge demanders' desired situation rather than a weight on the possession of professional licensing. However, this does not exclude expert matching in an embodiment.

Meanwhile, when an initial query regarding knowledge information or knowledge demand is acquired by the knowledge market server 100, the information may be processed so as not to be exposed to the outside by default.

This is because knowledge information, such as know-how, may lose value when exposed to the outside, and the initial query for knowledge demand may be related to the business strategy or future R&D direction of a company or research institution.

Particularly, in an embodiment, from the perspectives of the knowledge supplier and knowledge demander 410, information on who the counterparty is to each other or the knowledge information to be provided may be processed to be blinded, so that such information is not exposed to third parties, including the contracting parties under predetermined conditions until both parties agree to provide knowledge through the recommendation and enter into a contract. This is because, from the perspective of the knowledge supplier, the knowledge supplier may wish to avoid exposing that he or she is providing knowledge to someone or may prefer that his or her knowledge information remains unexposed until a contract is concluded, separately, from the perspective of the knowledge demander 410, the knowledge demander may not wish to expose which knowledge is in demand and is currently being developed or targeted.

The predetermined conditions herein may be a temporal condition, such as a period before a contract is concluded after a matching is made by a recommendation, but is not limited thereto. Further, the information blind-processed to not be exposed may be at least part of identity information used to identify the identity of the knowledge supplier or knowledge demander 410. For example, this may be a name, gender, age, or school of origin, including a social security number, but is not limited thereto. More specifically, the recommendation information provided to the knowledge supplier may include information on what field of knowledge the knowledge demander 410 wants, how much consideration he or she is willing to pay, what the scope of utilization of the knowledge is, and the like. However, information on who the knowledge demander 410 is, where he or she is located, and the like may not be provided and may be processed to be blinded. This may also be the same for information on the knowledge supplier that is recommended to the knowledge demander 410.

Meanwhile, in an embodiment, not only may the knowledge demander find a knowledge supplier, but the knowledge supplier may also find a knowledge demander to whom they wish to provide his or her knowledge. Therefore, active transactions or exchanges of knowledge may be made.

In addition, from the perspective of a knowledge demander or knowledge supplier, they do not need to worry about exposure of information that identifies their identity. This allows for more freedom in sharing their knowledge or receiving assistance from external experts. Hereinafter, a more detailed description of this knowledge market server 100 will be provided.

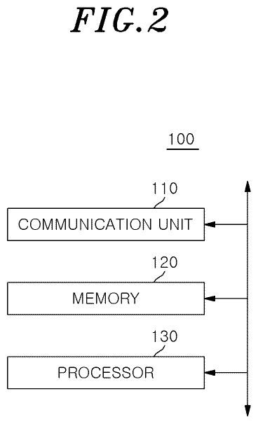

FIG. 2 illustrates an exemplary configuration diagram of the knowledge market server 100, according to an embodiment. With reference to FIG. 2, the knowledge market server 100 includes a communication unit 110, a memory 120, and a processor 130. However, the configuration diagram illustrated in FIG. 2 is exemplary only, and the spirit of the present disclosure should not be interpreted as being limited by the configuration diagram illustrated in FIG. 2. For example, the knowledge market server 100 may include at least one configuration not illustrated in FIG. 2 or may not include at least one of the configurations illustrated in FIG. 2.

The communication unit 110 may be implemented by a wired or wireless communication module. The knowledge market server 100 may perform communication with external terminals, such as various types of terminals or servers 200 to 400 illustrated in FIG. 1, through this communication unit 110.

The memory 120 may be implemented by a medium that stores information. This medium may be at least one storage medium among a flash memory type, a hard disc type memory, a multimedia card micro type memory, a card-type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc, but is not limited thereto.

Various types of information may be stored in this memory 120. For example, the memory 120 may store information acquired by the knowledge market server 100 through the communication unit 110 from an external terminal 200, etc. In addition, this memory 120 may store multiple training data that will be used for training different types of models or modules to be described below.

In addition, various types of modules or models may be implemented in the memory 120. When executed by the processor 130, which will be described below, these modules or models perform their intended function. Each module or model will be described below.

Next, the processor 130 will be described. First, the processor 130, according to an embodiment, may perform technical features according to embodiments of the present disclosure that will be described below by executing at least one instruction stored in the memory 120.

In an embodiment, the processor 130 may be configured with at least one core. Further, the processor 130 may be for data analysis and/or processing, such as a central processing unit (CPU), a general purpose graphics processing unit (GPGPU), a tensor processing unit (TPU), and the like.

The processor 130 described above may train a neural network or model designed using a machine learning or deep learning method. To this end, the processor 130 may perform computations for training the neural network, such as processing input data for training, extracting features from the input data, calculating errors, and updating weights of the neural network using backpropagation.

In addition, the processor 130 may perform inference for a predetermined purpose using a model implemented in an artificial neural network manner.

Hereinafter, the artificial neural network will be described. The model in the present specification may refer to any form of computer program that operates based on network functions, artificial neural networks, and/or neural networks. Throughout the present specification, the terms model, network function, and neural network may be used interchangeably. The neural network is configured of one or more nodes interconnected through one or more links to form input node and output node relationships within the neural network. The characteristics of a neural network may be determined by the number of nodes and links, the relationships between the nodes and links, and the weight values assigned to each link within the neural network. The neural network may be configured of a set of one or more nodes. A subset of nodes that configure the neural network may form a layer.

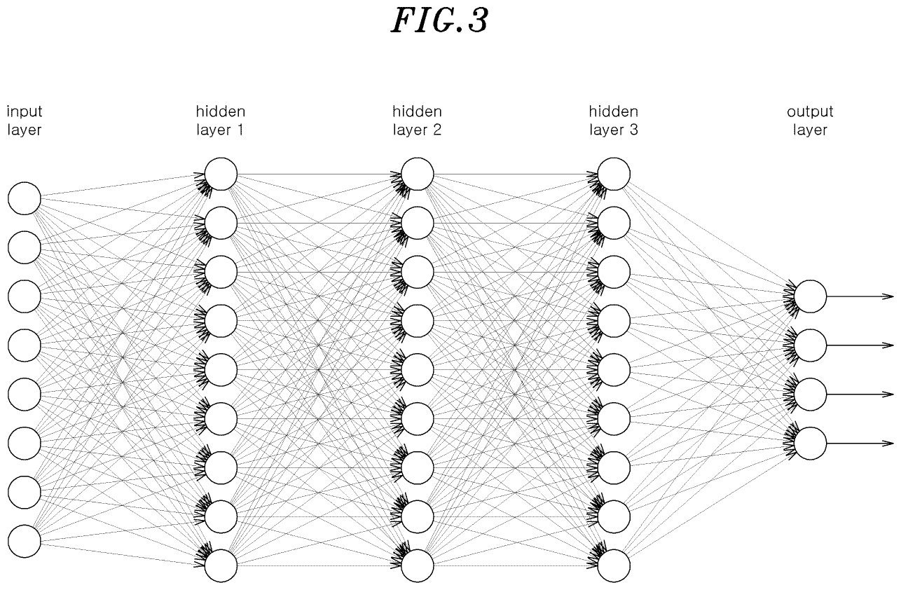

Among neural networks, a deep neural network (DNN) may refer to a neural network that includes multiple hidden layers in addition to an input layer and an output layer. The deep neural network, as the concept thereof is exemplarily illustrated in FIG. 3, may be configured of one or more hidden layers in the middle, In some embodiments two or more in the deep neural network.

The deep neural network may include a convolutional neural network (CNN), a recurrent neural network (RNN), a long short-term memory (LSTM) network, a generative pre-trained transformer (GPT), an auto encoder, a generative adversarial network (GAN), a restricted Boltzmann machine (RBM), a deep belief network (DBN), a Q-network, a U-network, a Siamese network, an generative adversarial network (GAN), and transformer, and the like.

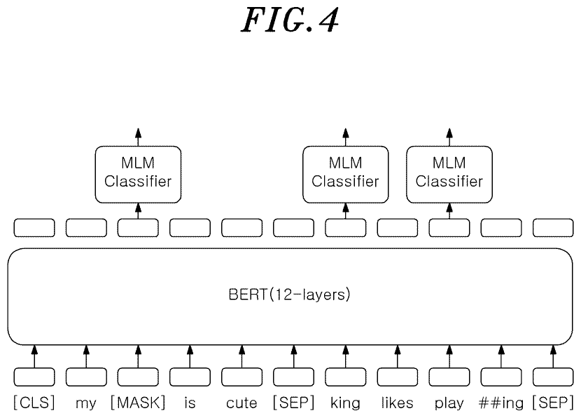

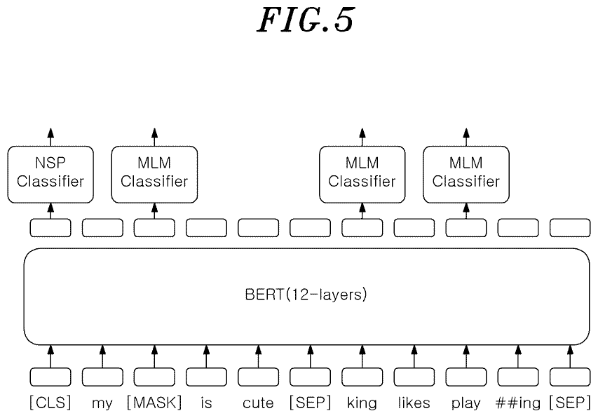

Alternatively, according to embodiments, the deep neural network may be a model trained using transfer learning. Here, transfer learning refers to a learning method in which a large amount of unlabeled training data is pre-trained in a semi-supervised or self-learning manner to obtain a pre-trained model (or base) with a first task through techniques (MLM and NSP) illustrated in FIGS. 4 and 5, respectively, and the labeled training data is trained in a supervised learning manner to implement a targeted model in order to fine-tune the pre-trained model to fit a second task. One of the models trained with the transfer learning method is bidirectional encoder representations from transformers (BERT), but is not limited thereto.

The neural network, including the deep neural network described above, may be trained to minimize error in the output. In the training of a neural network, the process may be performed by repeatedly inputting training data into the neural network, calculating the error of the output of the neural network for the training data and the target, and then backpropagating the error of the neural network from the output layer of the neural network toward the input layer in the direction of reducing the error to update the weights of each node of the neural network.

Meanwhile, a model according to an embodiment may be implemented to employ at least a portion of a transformer. Here, the transformer may be configured of an encoder to encode the embedded data and a decoder to decode the encoded data. The transformer may have a structure that receives a series of data, goes through encoding and decoding steps, and outputs a series of data of different types. In an embodiment, the series of data may be processed into a form that is computable by the transformer. The process of processing a series of data into a form that is computable by the transformer may include an embedding process. Expressions such as data token, embedding vector, embedding token may refer to embedded data in a form that the transformer can process.

In order for the transformer to encode and decode a series of data, the encoders and decoders within the transformer may utilize an attention algorithm. Here, the attention algorithm may refer to an algorithm that, for a given query, finds the similarity of one or more keys, reflects the given similarity to the values corresponding to each key, and then calculates the attention value by taking the weighted sum of the values with the similarity reflected.

In this case, depending on how the query, key, and value are set, various kinds of attention algorithms may be classified. For example, attention may be acquired by setting the query, key, and value to all be identical, which may refer to a self-attention algorithm. In contrast, to process a series of input data in parallel, attentions may also be acquired by reducing the dimensionality of the embedding vector and finding individual attentional heads for each segmented embedding vector, which may refer to a multi-head attentional algorithm.

In an embodiment, the transformer may be configured as a module that performs multiple multi-head self-attention algorithms or multi-head encoder-decoder algorithms. In an embodiment, the transformer may also include additional non-attention algorithmic components, such as embedding, normalization, or softmax. A method of configuring a transformer using an attention algorithm may include the method disclosed in Vaswani et al., Attention Is All You Need, 2017 NIPS, which is incorporated herein by reference.

The transformer may be applicable to various data domains, such as embedded natural language, segmented image data, or audio waveforms. As a result, the transformer may convert a series of input data into a series of output data. Data with various data domains may be converted to enable processing in the transformer, which is referred to as embedding.

In addition, the transformer may process additional data that expresses a relative positional or phase relationship among a series of input data. Alternatively, vectors expressing the relative positional or phase relationship among the input data may be further reflected in the series of input data, allowing the series of input data to be embedded. In one example, the relative positional relationship among a series of input data may include, but is not limited to, word order within a natural language sentence, relative positional relationship of each segmented image, temporal order of segmented audio waveforms, and the like. The process of adding information to express the relative positional or phase relationship among a series of input data may be referred to as positional encoding.

Hereinafter, various operations or functions that the knowledge market server 100 may perform will be described, as at least one instruction stored in the memory 120 is executed by the processor 130.

First, the processor 130 may control the communication unit 110. Accordingly, the knowledge market server 100 may perform communication with the terminal or server 200 to 400, etc. illustrated in FIG. 1 through the communication unit 110 to acquire information.

In addition, the processor 130 may read the aforementioned data or instructions stored in the memory 120, and may write new data or instructions to the memory 120. In addition, the processor 130 may modify or delete data or instructions that have already been recorded.

In addition, the processor 130 may execute various models or modules stored in the memory 120. Here, these models or modules may be implemented using the artificial neural network method described above or a rule-based method. For example, a language model and the like may be implemented. Hereinafter, the language model will be described.

A language model refers to a model generated on the basis of human language. This language model may be acquired in a variety of ways. In an embodiment, the language model may be acquired by transfer learning method. In transfer learning, as described above, the process is performed by pre-training a large amount of unlabeled training data (e.g., a corpus) in a semi-supervised or self-learning manner to obtain a pre-trained model (or base) with a first task. Subsequently, the process of fine-tuning the pre-trained model to fit a second task is performed. In this fine tuning, labeled training data is used for training in a supervised learning method. In an embodiment, one of the models trained using this transfer learning method includes, but is not limited to, bidirectional encoder representations from transformers (BERT), or generative pre-trained transformers (GPT).

Here, such a language model according to an embodiment may be chatGPT based on GPT-3 or GPT-4. Specifically, GPT-3 is a third generation language prediction model in the GPT-n series created by the company OpenAI. GPT-3 is configured of 175 billion parameters, more than twice the size of its predecessor GPT-2, which was introduced in May 2020. This is part of a pre-trained natural language processing (NLP) system of languages.

It is said that the tasks that GPT-3 may perform include various language-related problem solving, randomized writing, arithmetic, translation, simple web coding based on given sentences, and conversations.

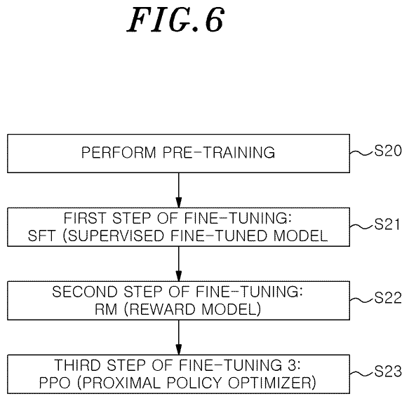

The learning process for such a language model is illustrated in FIG. 6. With reference to FIG. 6, in case of a language model according to an embodiment, the language model may be pre-trained (S20) with general language, or may be pre-trained based on at least one of papers, patent publications, and utility model publications. Therefore, more specialized searches for papers and patent documents become possible as a result. This is because, when pre-trained with a masked language model (MLM) or next sentence prediction (NSP) method based on papers, patent publications, or utility model publications, such pre-trained models may acquire a system for the way the aforementioned knowledge is described.

Additionally, in the fine-tuning of such a language model, reinforcement learning by human feedback (RLHF) may be performed. RLHF refers to the use of information judged by humans in learning for fine-tuning. For example, in the fine-tuning process of RLHF, a training process may be performed that uses a dialogue set generated by humans, as well as a training process that utilizes human-selected rankings for multiple outputs generated by the language model. More specifically, with reference to FIG. 6, a supervised fine-tuned model (SFT) is generated (S21) by a dialogue set generated by humans. Subsequently, human-selected rankings of the outputs from this SFT model are fed back to the corresponding model (RM, Reward Model) (S22), and then fine-tuning is performed (S23) by proximal policy optimization (PPO). Here, fine-tuning by PPO refers to a reinforcement learning policy algorithm, which continuously adjusts the current policy based on the tasks performed by the agent and the rewards received. In the PPO, the process proceeds in the sequence of new prompt->PPO->generate output->calculate reward, with the calculate reward being updated and provided back to a new prompt.

Such a language model may be utilized in various ways.

For example, a language model may be used to understand the meaning of a given word or sentence. Specifically, when the aforementioned initial query is given, the language model may understand the context of this initial query from the aforementioned knowledge database. More specifically, the language model understands the context in what specific sense the initial query is used socially or within a corresponding field in the current era by using a knowledge database that collects papers, patent documents, articles, or blogs, etc., which are publicly available up to that time. Subsequently, the language model generates a well-defined query that includes the context as understood in that way. In the process of generating a well-defined query, the language model may use the characteristics of a “generative model”, which is the fundamental characteristic that the language model has, but is not limited thereto. For example, when the initial query is given as a, the language model understands the meaning of a to be aa′. Further, using the initial query, a, and the context, aa′, the language model may generate a well-defined query, aaa′.

In addition, the language model may infer the degree of similarity of two given words, phrases, clauses, or sentences, and the like. For example, when an initial query is given, the language model may arrange and infer similar knowledge information to the given initial query among the multiple knowledge information already acquired, according to the degree of similarity and provide the knowledge information. In contrast, when knowledge information is given, the language model may arrange and infer initial queries in which such knowledge information may be used, according to the degree of similarity among multiple initial queries already given, and provide the initial queries. Of course, the language model may also infer and provide the degree of similarity between articles. For example, the language model may arrange and provide sources that are similar with each other in their content among papers, patents, or homepages according to the degree of similarity. In some cases, even the degree of similarity of knowledge may be inferred by such a language model. For example, whether the knowledge information of the knowledge supplier is related to the technical field dealt with by the institution or organization to which such a knowledge supplier has belonged in the past or currently belongs, and if there is a relationship, the degree thereof may be inferred by such a language model.

Additionally, the language model may be utilized in various ways. One of those is that the language model may extract at least one piece of paper information from the multiple papers, such as the author of the paper, the impact factor, and the institution to which the author of the corresponding paper belongs.

In addition, the language model may also be used to acquire various information. For example, when acquiring the specification of a molecular diagnostic kit, the language model may further use big-data prepared using research and development documents of similar or different types of kits to or from the kit. For example, a company that researches and develops a kit may have various kinds of research and development documents stored as big data, and the language model may access the data and acquire the specification of the aforementioned kit from the data. Of course, information that is not publicly disclosed in papers or the like may also be acquired from such big data.

In addition, the language model may access and acquire a marketability research material for the product.

In addition, when the product is a medical device, the language model may acquire information required for regulatory approval. Such information required for regulatory approval may include at least one of information on the source of clinical samples, or information on the country for which the regulatory approval is sought, and the institution where experiments for the regulatory approval are performed.

In addition, the language model may acquire information necessary for the production of the product.

In addition, the language model may acquire at least one of information on a target price (TP) for selling the product and an expected sales revenue.

Hereinafter, the functions that may be performed by the knowledge market server 100 as at least one instruction stored in the memory 120 is executed by the processor 130 will be described below. In this case, unless otherwise described herein, it is assumed that the functions described as being performed by the knowledge market server 100 are performed by executing at least one instruction stored in the memory 120 by the processor 130, as described above.

First, the knowledge market server 100 acquires knowledge information. The knowledge of such knowledge information may be manifested in various forms. For example, knowledge may be manifested not only in the form of patents or papers but also seminars in which the knowledge provider participates. In addition, knowledge may also be manifested in the form of know-how. The knowledge information thus acquired may be recorded on a blockchain, in which case the blockchain may be a private form, but is not limited thereto.

Such knowledge may be used across a variety of fields. For example, the knowledge may include solving problems that arise in everyday life. Alternatively, some knowledge may be applicable for developing or designing products or components of these products. In such development or design, the goal or outcome may be the development or design of product specifications (design specifications or performance specifications). The outcome may be blueprints or the like, but is not limited thereto.

Alternatively, some knowledge may be used to resolve a trouble in products or components. Alternatively, some knowledge may be used to implement a given function in products or components. Of course, the categories of knowledge are not limited thereto.

The aforementioned knowledge information may be acquired from a knowledge supplier. A knowledge supplier herein refers to an individual who has knowledge in one or more fields. Such a knowledge supplier may be a natural person. More specifically, a knowledge supplier may be an individual who is free from the constraints of employee inventions. An individual free from the constraints of employee inventions refers to, for example, in case of an employee of staff member, an individual who possesses knowledge unrelated to the duties of the institution to which the individual currently belongs or had belonged in the past and is able to provide such knowledge. Alternatively, it may refer to an individual who, after leaving the institution to which the individual was affiliated, has acquired knowledge solely through personal effort and is able to provide such knowledge. Alternatively, it may refer to, among the professors, an individual who, without the facilities or support of a university, has acquired and possesses knowledge through independent research and development and is able to provide such knowledge. In some cases, although the knowledge may technically be an employee invention, if the institution has previously recognized that the knowledge is the exclusive property of the individual, then the individual possessing the knowledge may also be free from the constraints of employee invention, as described above. Of course, if an individual who is not affiliated with any institution or organization is acquiring the knowledge, that individual who is able to provide the knowledge may also be considered to be free from the constraints of the employee invention described above.

Alternatively, the aforementioned knowledge information may be acquired by web crawling. In this case, information on at least one of the major, field of expertise, educational background, patent documents, papers or seminar performance history of each knowledge supplier may be acquired by web crawling. In this case, an described above, the external server 200, etc. illustrated in FIG. 1, may operate as a source capable of providing the aforementioned information.

In addition, the aforementioned knowledge information may be acquired from one or more knowledge suppliers, for example, each of multiple knowledge suppliers. That is, knowledge information may be acquired not only from multiple knowledge suppliers belonging to a single field, but also from multiple knowledge suppliers belonging to various fields. Therefore, the knowledge market server 100 may have a wide variety of knowledge information of numerous types.

Further, each piece of knowledge information may be acquired along with a detailed specification describing the corresponding knowledge information. For example, detailed things on who, what, when, why, and how may be acquired along with this knowledge information. Alternatively, for example, the knowledge information may include at least one of a time the corresponding knowledge supplier acquired the knowledge information, a reason for acquiring the corresponding knowledge information, a type of object related to the corresponding knowledge information, or properties of the object related to the corresponding knowledge information. In this case, such detailed specifications or knowledge information may be derived from actual case experiences of the corresponding knowledge supplier, but is not limited thereto.

That is, the detailed specification may refer to a detailed thing or exact fact regarding the knowledge information. According to an embodiment, each piece of knowledge information may further include cost information, which is an amount of money that the knowledge supplier wishes to receive as consideration for providing the corresponding knowledge information.

The acquired knowledge information in this manner may be updated. For example, information on newly published patent documents or papers, newly held seminars, newly established institutions or organizations, etc. may be acquired by web crawling or provision from the owner of the corresponding information. The knowledge information on the knowledge market server 100 may be updated by the knowledge information acquired in this manner.

In addition, the knowledge market server 100 acquires an initial query regarding the knowledge demand. Such an initial query may be acquired by the knowledge demander 410 inputting the initial query using his or her terminal 400. Alternatively, the initial query may be acquired by web crawling, etc. of technical requests uploaded by a specific organization or individuals on publicly accessible webpages, etc. Here, the acquirable knowledge demand is as described above. Therefore, further description will be omitted. The initial query thus acquired may be recorded on a blockchain, in which case the blockchain may be a private form, but is not limited thereto.

Here, the term “initial query” refers to a type of requirement that contains the matters requested by the knowledge demander. The term “initial query” indicates that it is in the exact form as input by the demander, but is not limited thereto. This initial query may be one or more sentences, and in some cases, may be in the form of a word, phrase, or clause. For example, “resolution of defects discovered in the process of using a PCR plate sealer” or “solutions for leakage occurring in water pipes” may be examples of such an initial query.

In the knowledge market server 100, recommendations for matching between the knowledge supplier and the knowledge demander 410 are performed. The recommended party may be one or more individuals. For example, among the multiple knowledge information stored in the knowledge market server 100, one or more knowledge suppliers that possess the knowledge information required by the knowledge demander 410 may be recommended to the knowledge demander 410. Then, the knowledge demander 410 may select a knowledge supplier is most suitable for the knowledge demander. Then, a matching is made between the knowledge supplier and the knowledge demander 410, a contract is concluded accordingly, and subsequently, the knowledge may be substantially transferred or delivered.

In contrast, among the multiple knowledge demands stored in the knowledge market server 100, one or more knowledge demanders 410 with knowledge demands that the knowledge supplier wishes to provide may be recommended to the knowledge supplier. For example, a knowledge supplier seeking employment or wishing to create a source of income using his or her knowledge may want to find a knowledge demand where his or her knowledge can be utilized. In this case, a suitable knowledge demand may be recommended to the corresponding knowledge supplier. In this case as well, the knowledge provider may select the knowledge demander 410 who is most suitable for himself or herself, resulting in a matching and contract, after which the knowledge may be substantially transferred or delivered.

That is, in an embodiment, for the perspective of a knowledge demander, not only may the knowledge demander find a knowledge supplier to provide knowledge to him or her, but the knowledge supplier may also find a knowledge demander to whom they wish to provide his or her knowledge. Therefore, active transactions or exchanges of knowledge may be made.

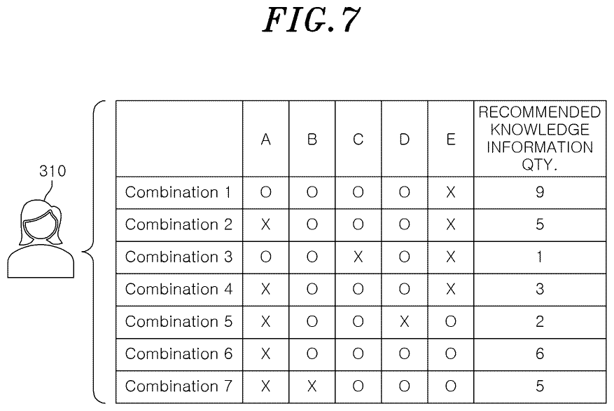

The knowledge information used for the recommendation, as described above includes the knowledge information described above and the knowledge demand expressed by the initial query. Here, according to an embodiment, the knowledge information used for the recommendation may be limited to that which the knowledge supplier has selected in advance. Among knowledge suppliers, there are cases where some desire that part of their knowledge information not be provided to third parties, including knowledge demander 410. Accordingly, in an embodiment, the knowledge supplier may preselect the knowledge information used for the recommendation. In this case, a combination of knowledge information, i.e., a combination may be generated according to the selection of the knowledge supplier. For example, a first combination may include items 1 to 5 of the knowledge information held by the knowledge supplier, while a second combination may include items 6 to 10 of the knowledge information held by the knowledge supplier. Then, in an embodiment, quantity information on the recommended knowledge demand may be provided to each knowledge supplier for each combination. Through the quantity information provided, the knowledge provider may identify the combinations that are most frequently recommended to him or her. Moreover, from the perspective of a knowledge supplier who wants to fulfill knowledge demand, the knowledge supplier may identify the combination in which his or her knowledge is most actively recommended and matched through various selections of knowledge information. FIG. 7 exemplarily illustrates which knowledge information is included in each combination and how many knowledge demands are recommended for each combination.

Meanwhile, according to an embodiment, an entity selecting the knowledge information to be used in recommendations may not be the knowledge supplier. For example, the aforementioned selection may be performed by a pre-trained knowledge information combination recommendation model. In this case as well, as described above, quantity information on the recommended knowledge information may be provided for each combination. In this case, the knowledge information combination recommendation model may be, when multiple knowledge information is given, a model trained to randomly select and combine two or more of the given multiple knowledge information, or a model trained to combine the relevant ones among the given multiple knowledge information, but is not limited thereto. When combinations are made among related ones, the aforementioned language model capable of understanding the semantic meaning of each piece of knowledge information may, of course, be employed in the knowledge information combination recommendation model described above, but is not limited thereto.

Meanwhile, the aforementioned knowledge demand used in the recommendation is not limited to the use of only the initial query. The initial query contains only the basic content input by knowledge demander 410, and thus may not fully express the knowledge demand. In practice, what knowledge or technology is desired by the knowledge demander 410 may become clearer not only from this initial query, but also when the meaning implied by the initial query is identified in a socially conventional way.

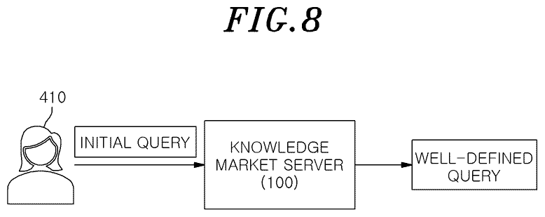

Accordingly, in an embodiment, not only the initial query indicating the knowledge demand, but also a well-defined query may be generated and used for the aforementioned recommendation. The well-defined query refers to one that uses the context of the initial query to extend its meaning or designate (well-defines) the details of the knowledge demand of the knowledge demander. To this end, while there are a variety of methods, in an embodiment, the knowledge market server 100, as illustrated in FIG. 8, and specifically the knowledge database or language model described above, may be used. More specifically, the meaning of the initial query, i.e., the context, is acquired from the knowledge database. This is because even if it is difficult to identify the meaning of the initial query itself, it is possible to identify the meaning of the initial query from socially conventional-used articles, such as patents, papers, or news articles. Alternatively, the meaning of the initial query may be identified using a language model. Depending on the context of the initial query, that is, what wordings are given before the initial query and what wordings are given after the initial query, the meaning of the initial query may be identified using these wordings. In an embodiment, the aforementioned language model may be used to identify the context of the initial query through such wordings given before and after the initial query, and the like. Alternatively, the aforementioned well-defined query may be generated using a response acquired by making a detailed request to the knowledge demander for the aforementioned initial query, which will be described below.

This well-defined query is a richer extension of the meaning of the initial query. Therefore, more information may be provided from such a well-defined query in understanding and identifying the knowledge demand of the knowledge demander 410.

Therefore, in an embodiment, the aforementioned knowledge demand used for the recommendation may be at least one of the initial query or the well-defined query described above. That is, according to an embodiment, only the initial query may be used, only the well-defined query may be used, or both the initial query and the well-defined query may be used simultaneously. When the well-defined query is used, this well-defined query may only be used after receiving confirmation of this well-defined query from the knowledge demander. When the initial query and the well-defined query are used simultaneously, they may be used in an interconnected or combined state, but are not limited thereto. In this case, depending on the situation, the knowledge demander 410 may select which query is to be used. For example, depending on the selection of the knowledge demander 410, only the initial query may be used for the recommendation, only the well-defined query may be used for the recommendation, or both the initial query and the well-defined query may be used for the recommendation.

Meanwhile, the method of generating a well-defined query is not limited to the aforementioned approach. For example, the well-defined query may be acquired using a response acquired by making a detailed request to the knowledge demander for the initial query.

The detailed request herein may include at least one of a range of required costs, a range of required time periods, a level of competence, a major, experience, gender, age, nationality, residence, and the number of patents or papers listed in which the name is listed in relation to the initial query, in order to solve the initial query. In addition, the response of the knowledge demander to such a detailed request may include a thing to be solved or achieved as the knowledge demand.

Here, the thing to be solved or achieved as a knowledge demand described above may take various forms. For example, the thing to be solved or achieved as the aforementioned knowledge demand may include (a) a time of the thing to be solved and issue occurrence, a cause of the issue occurrence, a type and characteristics of an object related to the issue, a period for solving the issue, and costs for solving the issue, and (b) a specific specification of the thing or target to be achieved, a period for achieving the thing or target, costs for achieving the thing or target, a current status of the knowledge demander related to the thing or target, the specific specification including at least one of a specification in terms of structure, composition, construction, or design or a specification in terms of performance, efficacy, or effect, but is not limited thereto.

Alternatively, for example, predefined characteristics for each type of initial query may be included in such a detailed request. Alternatively, contrasting characteristics among multiple knowledge suppliers may be included in such a detailed request.

Specifically, predefined characteristics for each type of initial query may include, for example, at least one of a range of required costs, a range of required time periods, a level of competence, a major, experience, gender, age, nationality, residence, and the number of patents or papers listed in which the name is listed in relation to the initial query, in order to solve the initial query, but are not limited thereto.

In addition, the aforementioned contrasting characteristics among multiple knowledge suppliers may refer to characteristics that each knowledge supplier has differently, rather than characteristics that all knowledge suppliers have in common, among the characteristics that each knowledge supplier has. For example, in case of gender, some may be male while others may be female, age ranges may differ, blood types may also differ. Therefore, these may be included as the contrasting characteristics. In addition, characteristics such as residence area, educational background, major, skill level in work, work experience, or profession are not characteristics that multiple knowledge suppliers share in common. Therefore, these may be included as the contrasting characteristics. Alternatively, the aforementioned characteristics may include information belonging to the same type but differing in content or information with different affiliation ranges of values when the information on the knowledge suppliers related to the initial query is classified according to type.

In this case, the aforementioned contrasting characteristics may be contrasting characteristics among multiple knowledge suppliers, but in some cases, may be contrasting characteristics among some knowledge suppliers of the multiple knowledge suppliers. In this case, “some of the knowledge suppliers” may be sorted in various ways, for example, individuals sorted based on relevance to the initial query of multiple knowledge suppliers may be these some knowledge suppliers, but are not limited thereto. To this end, a step may be performed to sort two or more knowledge suppliers related to the initial query among the multiple knowledge suppliers. In this case, “related to the initial query” means presumed to possess knowledge relevant to the initial query. To this end, a process may be performed that compares the initial query with the knowledge information from each knowledge supplier, and in this process, the aforementioned language model and the like may be used.

Next, once two or more knowledge suppliers are sorted in this manner, a detailed request may be extracted from the contrasting characteristics among the two or more knowledge suppliers.

In this case, in some cases, multiple contrasting characteristics included in the detailed request may be extracted, each differing from the others. Then, these multiple contrasting characteristics may have differing priorities, and the method of assigning each priority may vary. For example, when each characteristic is used to classify the aforementioned sorted knowledge suppliers into multiple groups, priorities may be assigned in the order in which the numerical deviation among knowledge suppliers belonging to each group is minimized. In this case, when filtering knowledge suppliers according to these priorities, the desired knowledge suppliers may be filtered most effectively. Meanwhile, in some cases, when a detailed request includes multiple contrasting characteristics, and each of the contrasting characteristics has an assigned priority, only the contrasting characteristics corresponding to the highest priority through the nth priority may be included in such a detailed request, but this is not limited thereto.

Meanwhile, when using multiple contrasting characteristics, each differing from the others, the targeted knowledge suppliers may be filtered over several times. For example, among the multiple knowledge suppliers, the knowledge suppliers related to the aforementioned initial query may be sorted. Then, the contrasting characteristics among the sorted knowledge suppliers may be acquired as a detailed request. Thereafter, by using the detailed request that includes the acquired contrasting characteristics, a first step may be performed in which some of the sorted knowledge suppliers are sorted. Subsequently, when contrasting characteristics are extracted among the knowledge suppliers sorted in this first step, a second step may be performed in which a detailed request including the extracted contrasting characteristics is acquired.

In this case, the aforementioned first and second steps may be repeatedly performed until the number of individuals of some of the knowledge suppliers sorted by the first step is equal to or less than a preset number.

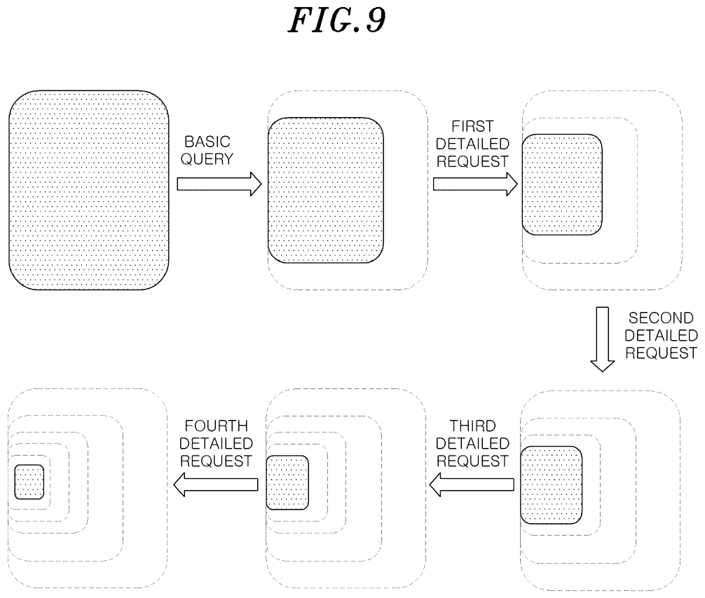

This will be described with an example with reference to FIG. 9. First, assume that the initial query is “how to remove stains from a dress shirt.” Then, the knowledge suppliers related to this initial query are filtered from the multiple knowledge suppliers.

Next, a first detailed request (or first contrasting characteristics) is acquired from the filtered knowledge suppliers. Then, some of the knowledge suppliers are filtered and retained using the acquired first detailed request.

Next, a second detailed request (or second contrasting characteristics) is acquired from some of the knowledge suppliers filtered and retained. Then, some of the knowledge suppliers are filtered and retained using the acquired second detailed request.

The aforementioned process may be repeated several times and may continue until the number of retained knowledge suppliers is equal to or less than a preset number.

Meanwhile, once the number of knowledge suppliers has been narrowed down, matching or recommendation with the knowledge demander may then be performed for these narrowed-down knowledge suppliers. This will be described in more detail below.

First, the knowledge market server 100 performs recommendations in various ways. For example, a recommendation model in which the aforementioned language model is employed may be used for such recommendations. More specifically, each of the knowledge demand and knowledge information is a language. Each of the knowledge demand and knowledge information may be a word, a phrase, or a clause, or may also be a sentence. In this case, the relevance, distance, or similarity between these may be measured by the aforementioned language model. Since the language model is a model trained to identify the meaning of a given language, the similarity between two or more given languages may also be acquired from this language model.

In this case, the recommendation model employing such a language model may be one that has been gone through the transfer learning, as described above. Specifically, in the pre-training process, various types of corpora may be used, and in the fine-tuning step, information on knowledge may particularly be used for training. In some cases, the corpora used in the pre-training process may include papers, patent publications, or utility model disclosures, but are not limited thereto.

Further, the training of such a recommendation model may use the aforementioned RLHF. In this case, as the RLHF has already been described in FIG. 6, redundant descriptions thereof will be omitted.

In the knowledge market server 100, various items may be used for recommendations. If the aforementioned recommendation model described above is used for the recommendations, at least one of the following items, in addition to knowledge information and knowledge demand, may also be used.
a recommendation history in a predetermined period for each knowledge supplier
a history of matching successes after the recommendation
a degree to which the knowledge demand is satisfied in the matching
the number of patents and/or papers related to the knowledge demand
the years of experience of the knowledge supplier related to the knowledge demand
a legal risk

In this case, for patents, a citation index, the number of foreign patent filing countries, the number of family patents, and the like may be further considered. In addition, for papers, and impact factor, the number of authors, and the like may also be further considered.

In this case, the extent to which each item is considered for the recommendation may be determined by a predetermined weight. These weights may differ for each item, and the values of these weights may be apparently determined by the deep learning or machine learning methods described above, and may also be arbitrarily adjusted by a human in some cases.

In particular, the legal risk among the aforementioned items will be described in the following. When a knowledge supplier provides knowledge information, whether such knowledge information is an employee invention under the Invention Promotion Act needs to be considered. If such knowledge information corresponds to an employee invention, the provision of the knowledge information itself may correspond to an act of disclosing the trade secrets of an institution or organization to the outside. That is, the aforementioned legal risks may include various aspects, and an embodiment will be described under the premise that whether the knowledge information corresponds to an employee invention is included.

First, there are several types that do not correspond to an employee invention. For example, it is sufficient that the knowledge supplier is an individual free from the constraints of employee inventions. Here, the individual free from the constraints of employee inventions refers to, for example, in case of an employee of staff member, an individual who possesses knowledge unrelated to the duties of the institution to which the individual currently belongs or has belonged in the past and is able to provide such knowledge. Alternatively, it may refer to an individual who, after leaving the institution to which the individual was affiliated, has acquired knowledge solely through personal effort and is able to provide such knowledge. Alternatively, it may refer to, among the professors, an individual who, without the facilities or support of a university, has acquired and possesses knowledge through independent research and development and is able to provide such knowledge. In some cases, although the knowledge may technically be an employee invention, if the institution has previously recognized that the knowledge is the exclusive property of the individual, then the individual possessing the knowledge may also be free from the constraints of employee invention, as described above. Of course, if an individual who is not affiliated with any institution or organization is acquiring the knowledge, that individual who is able to provide the knowledge may also be considered to be free from the constraints of the employee invention described above.

In this case, whether the knowledge information from the knowledge supplier corresponds to an employee invention needs to be identified, and in an embodiment, the aforementioned language model may be used for this identification. As described above, whether the knowledge information corresponds to an employee invention is determined by whether the duties of the current or former affiliated institution or organization of the knowledge supplier are related to this knowledge information of the knowledge supplier. That is, it is determined by whether they are semantically similar to each other. Since the language model may identify the semantic similarity between two given wordings, in an embodiment, whether the knowledge information corresponds to an employee invention may be identified using the language model.

Further, even if the knowledge information of the knowledge supplier corresponds to an employee invention, it may not be recognized by the knowledge demander 410, nor by the knowledge supplier. The knowledge supplier may also be unaware of the system of employee invention itself under the Invention Promotion Act.

Accordingly, in an embodiment, when the knowledge information from the knowledge supplier is determined to correspond to or has a high possibility of corresponding to an employee invention, in the knowledge market server 100, a warning message containing such content may be controlled to be displayed to at least one of the knowledge supplier and the knowledge demander 410. Such a display may be displayed on the terminal 300 of the knowledge supplier or the terminal 400 of the knowledge demander 410, but is not limited thereto. Alternatively, in some cases, when the knowledge information is determined to correspond to an employee invention, such knowledge information may be excluded from the recommendation.

Additionally, in an embodiment, when the knowledge information is determined to correspond to an employee invention and such a warning message is displayed to at least one of the two parties, the fact that the warning message was displayed may be recorded on a predetermined blockchain. Through such a record, the knowledge market server 100 may be somewhat free from liability for having encouraged or neglected the transaction or brokerage of knowledge information corresponding to an employee invention at a later date. As is well known, since information recorded on a blockchain cannot be altered or tampered with, the fact that the information on when the warning message stating that the knowledge information corresponds to an employee invention and caution is required in the transaction was sent to each party is recorded on such a blockchain may be adopted as evidence in potential liability disputes.

Meanwhile, the knowledge market server 100 may be provided with the conditions to be used for recommendations from each party 310 and 410. For example, from the perspective of the knowledge supplier, when the knowledge supplier does not wish to provide knowledge information to a specific company's knowledge demander 410, the knowledge supplier may record the name of that company in a predetermined exclusion condition. In addition, from the perspective of the knowledge demander 410, when the knowledge demander 410 wishes to exclude a knowledge supplier who has provided knowledge information to a specific company in the past, the knowledge demander 410 may record such information in a predetermined exclusion condition. Then, according to the recorded exclusion conditions, individuals who correspond to such exclusion conditions may be excluded from the recommendation. This applies to necessary conditions as well. For example, when a specific age or gender is desired, this may be recorded in a necessary condition, in which case only individuals who correspond to such a necessary condition may be sorted in the recommendation.

Meanwhile, the recommended individuals may be more than one, and in some cases, may be a team. In this case, this team may be either designated by at least one of the knowledge suppliers or recommended by a pre-trained team recommendation model using the knowledge information from each knowledge supplier. If a team recommendation model is provided, this team recommendation model may a model that forms teams to group the knowledge suppliers with similar knowledge information by comparing the knowledge information from each knowledge supplier using the language model, but is not limited thereto.

In the knowledge market server 100, a contract is concluded between the knowledge supplier and the knowledge demander 410 by the recommendation. Through this conclusion of a contract, the knowledge demander 410 may be provided with knowledge information from the knowledge supplier.

In this case, the contract may include at least one of the following items. For example, at least one of a period, a consideration, an agreed scope between the contracting parties for the knowledge information from the knowledge supplier to be utilized, ownership of inventions that may be derived in the process of fulfilling the knowledge demand or workability of a technology proposed for the knowledge demand, may be included in such items.

Here, the aforementioned compensation may also be referred to as a success fee. Further, this consideration may be determined to be different in a case where the agreed scope between the contracting parties for the knowledge information from the knowledge supplier to be utilized is limited to the knowledge demand and in a case where the agreed scope is specified to be expandable with the knowledge demand included. That is, the knowledge information may be restricted to be utilized to the field designated at the time of the contract or may be described in the contract to be extended to other fields, and the consideration in each case may be determined differently.

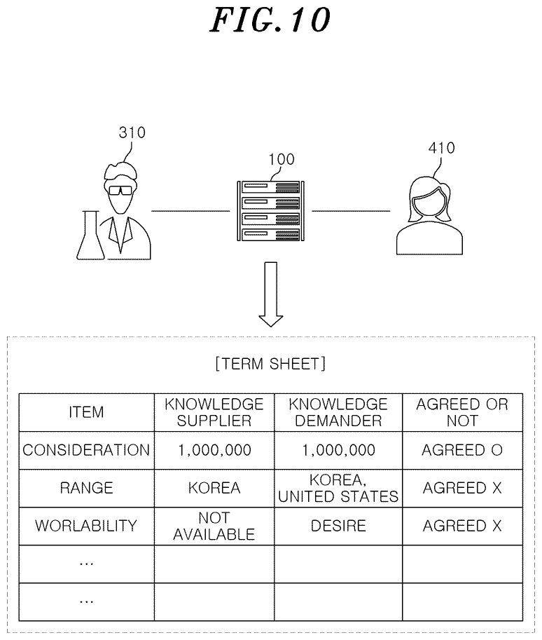

Meanwhile, in the knowledge market server 100, a term sheet may be generated, as illustrated in FIG. 10, prior to the aforementioned contract. The term sheet refers to a document in which the desired aspects of each contracting party are described. To this end, the following steps may be performed: acquiring requests from each of the knowledge supplier and the knowledge demander 410, generating and providing a term sheet on which the acquired requests are collected and described to each party. In this case, in this term sheet, among requests acquired from both parties, requests on which mutual opinions have been agreed upon and requests on which mutual opinions have not been agreed upon, may be separately marked. Therefore, both parties to the contract may quickly and accurately identify the aspects that require mutual coordination through such a term sheet.

Meanwhile, in the knowledge market server 100, two or more knowledge supplier may be recommended as the form of a team, but in contrast, the knowledge suppliers may also be recommended as bidders who need to compete against each other. In this case, the two or more knowledge supplier need to win the bid through bidding against each other as the knowledge supplier to fulfill a specific knowledge demand, thereby providing knowledge information.

Meanwhile, in the knowledge market server 100, at least part of the identity information for identifying the recommended individual, i.e., an identity of at least one of the knowledge supplier and the knowledge demander 410, may be processed to be blinded under predetermined conditions. This is because knowledge information, such as know-how, may lose value when exposed to the outside, and the initial query for knowledge demand may be related to the business strategy or future R&D direction of a company or research institution.

Particularly, in an embodiment, from the perspectives of the knowledge supplier and knowledge demander 410, information on who the counterparty is to each other may be processed to be blinded, so that such information is not exposed to third parties, including the contracting parties under predetermined conditions until both parties agree to provide knowledge through the recommendation and enter into a contract. This is because, from the perspective of the knowledge supplier, the knowledge supplier may wish to avoid exposing that he or she is providing knowledge to someone, in contrast, from the perspective of the knowledge demander 410, the knowledge demander may not wish to expose which knowledge is in demand and is currently being developed or targeted.

The predetermined conditions herein may be a temporal condition, such as a period before a contract is concluded after a matching is made by a recommendation, but is not limited thereto. Further, the information blind-processed to not be exposed may be at least part of identity information used to identify the identity of the knowledge supplier or knowledge demander 410. For example, this may be a name, gender, age, or school of origin, including a social security number, but is not limited thereto. More specifically, the recommendation information provided to the knowledge supplier may include information on what area of knowledge the knowledge demander 410, who matches with the knowledge information of the knowledge supplier, himself or herself, wants, how much consideration he or she is willing to pay, what the scope of utilization of the knowledge is, and the like. However, information on who the knowledge demander 410 is, where he or she is located, and the like may not be provided and may be blind-processed. This may also be the same for information on the knowledge supplier that is recommended to the knowledge demander 410.

As described above, in an embodiment, from the perspective of a knowledge demander, not only may the knowledge demander find a knowledge supplier to provide knowledge to him or her, but the knowledge supplier may also find a knowledge demander to whom they wish to provide his or her knowledge. Therefore, active transactions or exchanges of knowledge may be made.

Meanwhile, prior to the conclusion of the aforementioned contract, it may be controlled such that no knowledge information is provided from the knowledge supplier to the knowledge demander. Otherwise, there may be a risk of the knowledge information from the knowledge supplier being unnecessarily disclosed to a third party.

In addition, depending on the process in which knowledge information is provided from the knowledge supplier to the knowledge demander, the time or process of payment according to the aforementioned compensation may be controlled. For example, payment may not be made before the knowledge information has been delivered. However, it may be controlled such that payment is made only after the knowledge information has been fully delivered, and more specifically, after confirmation by the knowledge demander or after the corresponding technology has been fully implemented for one complete cycle by the knowledge demander.

Meanwhile, in the knowledge market server 100 according to an embodiment, it is verified whether the party who intends to provide, is providing, or has provided knowledge information to the knowledge demander is the knowledge supplier matched by recommendation or contract in the knowledge market server 100. Otherwise, there is a risk that a third party, rather than the recommended or contracted individual, may provide the knowledge information.

To this end, in the knowledge market server 100 according to an embodiment, a procedure for verifying the identity of the individual who has provided, is providing, or will provide the knowledge information to the knowledge demander is performed. For example, using biometric information or identity card information, etc. on the aforementioned individual, the knowledge market server 100, according to an embodiment, may perform an identification of whether the aforementioned individual is a same individual who was recommended or contracted to provide knowledge information to the knowledge demander. Here, since the technology itself for identifying the identity using biometric information or identity card information is already publicly known, a detailed description thereof will be omitted.

Meanwhile, the knowledge information uploaded to the knowledge market server 100 or subject to transaction in the knowledge market server 100 is exclusively attributed to the entity that uploaded the corresponding knowledge information, i.e., the knowledge supplier. Specifically, at least part of such information or bibliographic details may be uploaded to the knowledge market server 100, but despite thus being in an uploaded state, ownership of the uploaded information remains exclusively attributed to the knowledge supplier. The knowledge market server 100 merely temporarily stores such information for recommendation or matching purposes and does not hold ownership of the information itself.

Meanwhile, a method of operating the knowledge market server 100 will be described hereinafter.

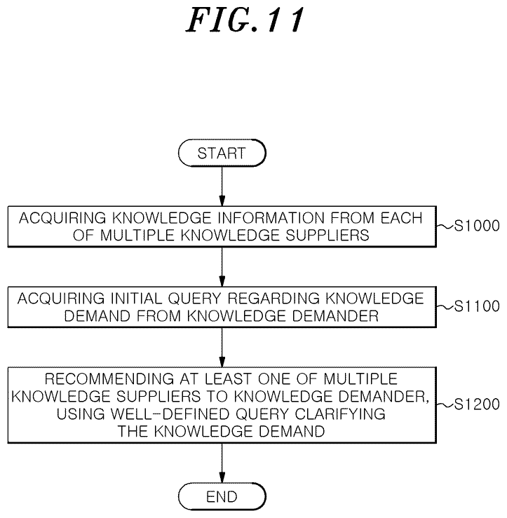

FIG. 11 exemplarily illustrates a flowchart representing a procedure of a method of operating a knowledge market server, according to an embodiment. Here, the flowchart is merely exemplary, and the spirit of the present disclosure is not limited thereto. For example, according to an embodiment, each step may be performed in an order different from that illustrated in FIG. 11, or at least one step not illustrated in FIG. 11 may further be performed, or at least one of the steps illustrated in FIG. 11 may not be performed.

With reference to FIG. 11, a step (S1000) in which knowledge information from each of multiple knowledge suppliers is acquired is performed. Here, the knowledge information includes (a) details regarding the knowledge that a knowledge supplier has, (b) a personal profile of the knowledge supplier, and (c) a consideration for provision of the knowledge information.

In addition, a step (S1100) in which an initial query regarding a knowledge demand is acquired from a knowledge demander is performed.

In addition, a step (S1200) is performed in which at least one of the multiple knowledge suppliers is recommended to the knowledge demander using a well-defined query that clarifies the knowledge demand. The well-defined query is obtained from a response that is acquired by making a request for the acquired (i) knowledge information from multiple knowledge suppliers and (ii) initial query on the knowledge demander or a detailed request for the initial query, to the knowledge demander. In this case, at least part of the information that is usable for recognizing identification of the multiple knowledge suppliers or the knowledge demander is processed to be blinded to prevent exposure.

Meanwhile, since the description of this operating method overlaps that of the knowledge market server 100 already described above, the redundant description will be omitted.

Combinations of each block of the block diagrams and each step of the flowchart attached to the present disclosure may be performed by computer program instructions. Since these computer program instructions can be installed in an encoding processor of a general-purpose computer, a special-purpose computer, or other programmable data processing equipment, the instructions executed through the encoding processor of the computer or other programmable data processing equipment generate means for executing functions described in each block of the block diagrams or each step of the flowchart. These computer program instructions may also be stored in a computer-usable or computer-readable memory that can be directed to computers or other programmable data processing equipment to implement functions in a particular way, and thus the instructions stored in the computer-usable or computer-readable memory can also produce manufactured items containing instruction means for executing the functions described in each block of the block diagram or each step of the flowchart. Since the computer program instructions can also be installed in a computer or other programmable data processing equipment, a series of operational steps may be performed on the computer or other programmable data processing equipment to create a process that is executed by the computer, thereby providing steps for executing the functions described in each block of the block diagrams and each step of the flowchart through the instructions.

Additionally, each block or each step may represent a module, a segment, or some code that includes one or more executable instructions for executing specified logical function(s). Additionally, it should be noted that, in some alternative embodiments, the functions mentioned in blocks or steps are executed out of order. For example, two blocks or steps shown in succession may be performed substantially simultaneously, or the blocks or steps may sometimes be performed in reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A knowledge market server comprising:
a memory storing at least one instruction; and
a processor,
wherein knowledge information from each of multiple knowledge suppliers is acquired through the at least one instruction being executed by the processor,
wherein the knowledge information includes:
details of knowledge that a knowledge supplier has;
a personal profile of the knowledge supplier; and
a cost associated with providing the knowledge information,
wherein an initial query regarding a knowledge demand is acquired from a knowledge demander,
wherein at least one of the multiple knowledge suppliers is recommended to the knowledge demander using a well-defined query, the well-defined query clarifying the knowledge demand obtained from a response that is acquired by making a request for the acquired (i) knowledge information from multiple knowledge suppliers and (ii) the initial query on the knowledge demander or a detailed request for the initial query, to the knowledge demander, and
wherein at least some information usable for recognizing identification of the multiple knowledge suppliers or the knowledge demander is processed to be blinded to prevent exposure.

2. The knowledge market server of claim 1, wherein the knowledge information is acquired by web crawling or by being provided by each of the multiple knowledge suppliers.

3. The knowledge market server of claim 1, wherein the detailed request includes at least one of a range of required costs, a range of required time periods, a level of competence, a major, experience, gender, age, nationality, residence, and the number of patents or papers listed in which the name is listed in relation to the initial query, in order to solve the initial query.

4. The knowledge market server of claim 1, wherein the knowledge demander's response to the detailed request includes a thing to be solved or achieved as the knowledge demand,
wherein the thing to be solved or achieved includes:
a time of the thing to be solved and issue occurrence, a cause of the issue occurrence, a type and characteristics of an object related to the issue, a period for solving the issue, and costs for solving the issue; and
a specific specification of the thing or target to be achieved, a period for achieving the thing or target, costs for achieving the thing or target, a current status of the knowledge demander related to the thing or target, and
wherein the specific specification includes at least one of a specification in terms of structure, composition, construction, or design or a specification in terms of performance, efficacy, or effect.

5. The knowledge market server of claim 1, wherein the details of the knowledge that the knowledge supplier has includes at least one of a patent listing the knowledge supplier as an inventor, an academic paper, post, or seminar listing the knowledge supplier as an author or presenter, or a description of the knowledge to be provided.

6. The knowledge market server of claim 5, wherein the description of the knowledge to be provided includes a description of solvable issues and/or a description of achievable targets,
wherein the description of solvable issues includes at least one of a cause of the issue, a type and characteristics of objects related to the issue, a time required for issue resolution, and a cost of issue resolution,
wherein the description of achievable targets includes at least one of specific specifications of the target, a time required to achieve the target, and a cost to achieve the target, and
wherein the specific specifications have at least one of specifications in terms of structure, composition, construction, or design, and specifications in terms of performance, efficacy, or effect.

7. The knowledge market server of claim 1, wherein as the at least one instruction is executed by the processor, two or more knowledge suppliers from multiple knowledge suppliers are sorted using the acquired initial query, extracting the detailed request is extracted from contrasting characteristics among the sorted two or more knowledge suppliers, and
wherein the detailed request requested to the knowledge demander includes the extracted detailed request.

8. The knowledge market server of claim 7, wherein as the at least one instruction is executed by the processor, a first step is performed of sorting a part from the sorted two or more knowledge suppliers using the extracted detailed request, and a second step is performed of additionally extracting the detailed request from contrasting characteristics among the sorted part of knowledge suppliers,
wherein the first and second steps are repeatedly performed until the number of individuals of the part sorted in the first step is equal to or less than a preset number.

9. The knowledge market server of claim 1, wherein the recommendation is performed by a recommendation language model trained by fine-tuning a pre-trained model based on at least one of papers, patent publications, and utility model publications.

10. The knowledge market server of claim 1, wherein multiple items are further used in the recommendation, and
wherein the multiple items include at least one of a recommendation history in a predetermined period for each knowledge supplier, a history of matching successes after the recommendation, a degree to which the knowledge demand is satisfied in the matching, the number of patents and/or papers related to the knowledge demand, and the years of experience of the knowledge supplier related to the knowledge demand, a existence of a legal risk.

11. The knowledge market server of claim 10, the legal risk is determined according to whether knowledge information from each knowledge supplier corresponds to an employee invention of a current or former affiliated organization of the corresponding knowledge supplier.

12. The knowledge market server of claim 1, wherein, as the at least one instruction is executed by the processor, when the knowledge information from the knowledge supplier recommended to the knowledge demander is determined to correspond to an employee invention, a warning message indicating the possibility that the knowledge information from the recommended knowledge supplier corresponds to an employee invention is controlled to be displayed to at least one of the knowledge demander or the recommended knowledge supplier.

13. The knowledge market server of claim 1, wherein, as the at least one instruction is executed by the processor, inclusion criteria or exclusion criteria to be considered in the recommendation are input from the knowledge demander, and the recommended knowledge supplier is an individual sorted by the inclusion criteria and the exclusion criteria among the multiple knowledge suppliers.

14. The knowledge market server of claim 1, wherein a contract to fulfill the knowledge demand is concluded between the knowledge supplier and the knowledge demander by the recommendation.

15. The knowledge market server of claim 14, wherein the contract includes at least one of a period, consideration, an agreed scope between the contracting parties for the knowledge information from the knowledge supplier to be utilized, ownership of inventions that may be derived in the process of fulfilling the knowledge demand, or workability of a technology proposed for the knowledge demand.

16. The knowledge market server of claim 14, wherein requests for the contract is acquired from each of the knowledge supplier and the knowledge demander by the recommendation, and a term sheet on which the acquired request is collected and described is generated and provided to each of the knowledge supplier and the knowledge demander by the recommendation.

17. The knowledge market server of claim 1, wherein as the at least one instruction is executed by the processor, an interface for specifying ownership of the knowledge information delivered from the knowledge supplier to the knowledge demander is provided to the knowledge supplier and the knowledge demander.

18. The knowledge market server of claim 1, wherein as the at least one instruction is executed by the processor, an interface for specifying a scope of rights and/or obligations of each of the knowledge supplier and the knowledge demander with respect to the outcome to which the knowledge information has been applied is provided to the knowledge supplier and the knowledge demander.

19. A method of operating a knowledge market performed by a knowledge market server, the method comprising:
acquiring knowledge information from each of multiple knowledge suppliers, the knowledge information including
details of knowledge that a knowledge supplier has,
a personal profile of the knowledge supplier, and
a cost associated with providing the knowledge information;
acquiring an initial query regarding a knowledge demand from a knowledge demander; and
recommending, to the knowledge demander, at least one of the multiple knowledge suppliers using a well-defined query, the well-defined query clarifying the knowledge demand obtained from a response that is acquired by making a request for the acquired knowledge information from multiple knowledge suppliers and initial query on the knowledge demander or a detailed request for the initial query, to the knowledge demander, and
wherein at least some of information usable for recognizing identification of the multiple knowledge suppliers or the knowledge demander is processed to be blinded to prevent exposure.

20. A non-transitory computer-readable recording medium storing a computer program programmed to perform each step included in a method, the method comprising:
acquiring knowledge information from each of multiple knowledge suppliers, the knowledge information including:
details of knowledge that a knowledge supplier has,
a personal profile of the knowledge supplier, and
a cost associated with providing the knowledge information;
acquiring an initial query regarding a knowledge demand from a knowledge demander; and
recommending, to the knowledge demander, at least one of the multiple knowledge suppliers using a well-defined query, the well-defined query clarifying the knowledge demand obtained from a response that is acquired by making a request for the acquired knowledge information from multiple knowledge suppliers and initial query on the knowledge demander or a detailed request for the initial query, to the knowledge demander, and
wherein at least some of information usable for recognizing identification of the multiple knowledge suppliers or the knowledge demander is processed to be blinded to prevent exposure.
